(19) United States
(12) Patent Application Publication
(10) Pub. No.: US 2024/0154087 A1
(43) Pub. Date: May 9, 2024

(54) CATHODE MATERIALS AND METHODS OF MAKING THE SAME

(71) Applicant: Rivian IP Holdings, LLC, Irvine, CA (US)

(72) Inventors: Majid Talebiesfandarani, San Jose, CA (US); Guoxian Liang, Sunnyvale, CA (US); Victor Ken Prajapati, San Francisco, CA (US)

(73) Assignee: Rivian IP Holdings, LLC, Irvine, CA (US)

(21) Appl. No.: 18/492,917

(22) Filed: Oct. 24, 2023

Related U.S. Application Data
(60) Provisional application No. 63/382,354, filed on Nov. 4, 2022.

(51) Int. Cl. H01M 4/04; H01M 4/38; H01M 4/505; H01M 4/58; H01M 10/052

(52) U.S. Cl. CPC H01M 4/0483; H01M 4/0471; H01M 4/382; H01M 4/505; H01M 4/58; H01M 10/052; H01M 2004/028

(57) ABSTRACT

Provided herein is a method of producing cathode materials. The method can include heating precursors in a first vessel to a first temperature to form heated precursors. The first temperature can be below a melting point of a solid including a compound formed from the precursors. The method can include transferring the heated precursors from the first vessel to a second vessel. The method can include heating the heated precursors to a second temperature to form a liquid. The second temperature can be at or above the melting point of the solid including the compound formed from the precursors.

### CROSS-REFERENCE TO RELATED APPLICATION

This application claims the benefit of and priority to U.S. Provisional Patent Application No. 63/382,354, filed on Nov. 4, 2022, the entire contents of which are hereby incorporated by reference in its entirety.

### INTRODUCTION

Batteries can have different power capacities to charge and discharge power to operate machines.

### SUMMARY

Precursors for cathode materials such as lithium metal phosphates (e.g., lithium iron phosphate, lithium manganese iron phosphate or their derivatives) that can have low heat conductivity and can take an extended time to heat and melt. The apparatuses, systems, and methods described herein can reduce the heating time of precursor materials and improve the quality of cathode materials.

At least one aspect is directed to a method. The method can include heating precursors in a first vessel to a first temperature to form heated precursors. The first temperature can be below a melting point of a solid including a compound formed from the precursors. The method can include transferring the heated precursors from the first vessel to a second vessel. The method can include heating the heated precursors to a second temperature to form a liquid. The second temperature can be at or above the melting point of the solid including the compound formed from the precursors.

At least one aspect is directed to a system. The system can include a first vessel configured to heat precursors to a first temperature to form heated precursors. The first temperature can be below a melting point of a solid including a compound formed from the precursors. The system can include a second vessel configured to receive the heated precursors. The system can include a furnace configured to heat the heated precursors to a second temperature to form a liquid. The second temperature can be at or above the melting point of the solid including the compound formed from the precursors.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an electric vehicle, according to an example implementation.

FIG. 2 depicts a cross sectional view of a battery cell, according to an example implementation.

FIG. 3 depicts a perspective view of a system for producing cathode materials, according to an example implementation.

FIG. 4 depicts a perspective view of a method to produce cathode materials, according to an example implementation.

FIG. 5 depicts a perspective view of a method to produce cathode materials, according to an example implementation.

### DETAILED DESCRIPTION

Following below are more detailed descriptions of various concepts related to, and implementations of, methods, apparatuses, and systems of producing cathode materials. The various concepts introduced above and discussed in greater detail below may be implemented in any of numerous ways.

The present disclosure is directed to systems and methods of producing cathode materials. Cathode materials can include lithium metal phosphate cathode materials. These cathode materials can be formed from precursors. However, there are challenges with heating and melting the precursors to form cathode materials. For example, the precursors can have low heat conductivity and can take an extended time to heat and melt. The extended heating time can lead to side reactions and difficulty in controlling the processing and quality of the melt.

Addressing these problems, a technical solution described herein can include a method of producing cathode materials. The method can include heating precursors in a first vessel to a first temperature to form heated precursors. The first temperature can be below a melting point of a solid including a compound formed from the precursors. The method can include transferring the heated precursors from the first vessel to a second vessel. The method can include heating the heated precursors to a second temperature to form a liquid. The second temperature can be at or above the melting point of the solid including the compound formed from the precursors.

The disclosed solutions have a technical advantage of quickly heating and melting the precursors. The solutions can reduce or suppress side reactions. The solutions can improve the quality of the melt. The solutions can increase the throughput of the melt furnace. The solutions can improve product quality (e.g., quality of the cathode). The solutions can reduce the amount of time at the melt temperature. The solutions can produce lithium metal phosphate cathode materials using low-cost iron, manganese, and phosphate sources and doping additives in a molten state. This can allow for a complete reaction at the atomic scale and uniform doping to achieve high performance cathode materials.

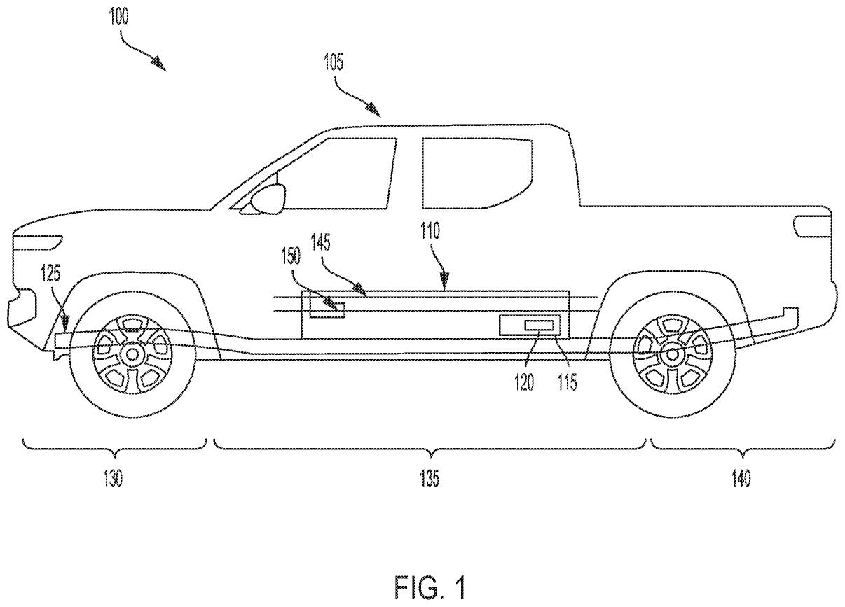

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, batteries 115 or battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery 115, the battery modules 115, or the battery cells 120 with other electrical components of the electric vehicle 105 to provide electrical power to various systems or components of the electric vehicle 105.

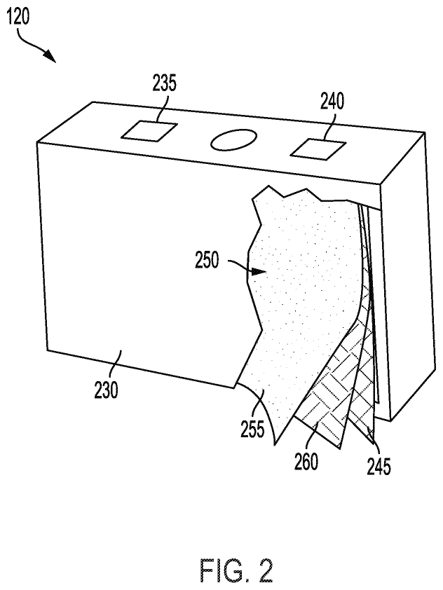

Battery cells 120 have a variety of form factors, shapes, or sizes. For example, battery cells 120 can have a cylindrical, rectangular, square, cubic, flat, pouch, elongated or prismatic form factor. As depicted in FIG. 2, for example, the battery cell 120 can be prismatic. Battery cells 120 can be assembled, for example, by inserting a winded or stacked electrode roll (e.g., a jelly roll) including electrolyte material into at least one battery cell housing 230. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 120 can include an electrolyte layer where the electrolyte layer can be or include solid electrolyte material that can conduct ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 120. The housing 230 can be of various shapes, including cylindrical or rectangular, for example. Electrical connections can be made between the electrolyte material and components of the battery cell 120. For example, electrical connections to the electrodes with at least some of the electrolyte material can be formed at two points or areas of the battery cell 120, for example to form a first polarity terminal 235 (e.g., a positive or anode terminal) and a second polarity terminal 240 (e.g., a negative or cathode terminal). The polarity terminals can be made from electrically conductive materials to carry electrical current from the battery cell 120 to an electrical load, such as a component or system of the electric vehicle 105.

For example, the battery cell 120 can include at least one lithium-ion battery cell. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 120 to separate the anode and cathode from each other and to facilitate transfer of lithium ions between the anode and cathode. It should be noted that battery cell 120 can also take the form of a solid-state battery cell developed using solid electrodes and solid electrolytes. Solid electrodes or electrolytes can be or include inorganic solid electrolyte materials (e.g., oxides, sulfides, phosphides, ceramics), solid polymer electrolyte materials, hybrid solid-state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid-state electrolyte), for example, polyacrylonitrile (PAN), polyethylene oxide (PEO), polymethyl-methacrylate (PMMA), and polyvinylidene fluoride (PVDF), among others.

The battery cell 120 can be included in battery modules 115 or battery packs 110 to power components of the electric vehicle 105. The battery cell housing 230 can be disposed in the battery module 115, the battery pack 110, or a battery array installed in the electric vehicle 105. The housing 230 can be of any shape, such as cylindrical with a circular, elliptical, or ovular base, among others. The shape of the housing 230 can also be prismatic with a polygonal base among others. The housing 230 can include a pouch form factor. The housing 230 can include other form factors, such as a triangle, a square, a rectangle, a pentagon, and a hexagon, among others. In some embodiments, the battery pack may not include modules (e.g., module-free). For example, the battery pack can have a module-free or cell-to-pack configuration where the battery cells are arranged directly into a battery pack without assembly into a module.

The housing 230 of the battery cell 120 can include one or more materials with various electrical conductivity or thermal conductivity, or a combination thereof. The electrically conductive and thermally conductive material for the housing 230 of the battery cell 120 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 230 of the battery cell 120 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing 230 of the battery cell 120 is prismatic or cylindrical, the housing 230 can include a rigid or semi-rigid material such that the housing 230 is rigid or semi-rigid (e.g., not easily deformed or manipulated into another shape or form factor). In examples where the housing 230 includes a pouch form factor, the housing 230 can include a flexible, malleable, or non-rigid material such that the housing 230 can be bent, deformed, manipulated into another form factor or shape.

The battery cell 120 can include at least one anode layer 245, which can be disposed within the cavity 250 defined by the housing 230. The anode layer 245 can include a first redox potential. The anode layer 245 can receive electrical current into the battery cell 120 and output electrons during the operation of the battery cell 120 (e.g., charging or discharging of the battery cell 120). The anode layer 245 can include an active substance. The active substance can include, for example, an activated carbon or a material infused with conductive materials (e.g., artificial or natural graphite, or blended), lithium titanate (Li₄Ti₅O₁₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp² hybridization), Li metal anode, or a silicon-based carbon composite anode, or other lithium alloy anodes (Li—Mg, Li—Al, Li—Ag alloy etc.) or composite anodes consisting of lithium and carbon, silicon and carbon or other compounds. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 120 can include at least one cathode layer 255 (e.g., a composite cathode layer compound cathode layer, a compound cathode, a composite cathode, or a cathode). The cathode layer 255 can include a second redox potential that can be different than the first redox potential of the anode layer 245. The cathode layer 255 can be disposed within the cavity 250. The cathode layer 255 can output electrical current out from the battery cell 120 and can receive electrons during the discharging of the battery cell 120. The cathode layer 255 can also receive lithium ions during the discharging of the battery cell 120. Conversely, the cathode layer 255 can receive electrical current into the battery cell 120 and can output electrons during the charging of the battery cell 120. The cathode layer 255 can release lithium ions during the charging of the battery cell 120.

The battery cell 120 can include an electrolyte layer 260 disposed within the cavity 250. The electrolyte layer 260 can be arranged between the anode layer 245 and the cathode layer 255 to separate the anode layer 245 and the cathode layer 255. A separator can be wetted with a liquid electrolyte. The liquid electrolyte can be diffused into the anode layer 245. The liquid electrolyte can be diffused into the cathode layer 255. The electrolyte layer 260 can help transfer ions between the anode layer 245 and the cathode layer 255. The electrolyte layer 260 can transfer Li+ cations from the anode layer 245 to the cathode layer 255 during the discharge operation of the battery cell 120. The electrolyte layer 260 can transfer lithium ions from the cathode layer 255 to the anode layer 245 during the charge operation of the battery cell 120.

The redox potential of layers (e.g., the first redox potential of the anode layer 245 or the second redox potential of the cathode layer 255) can vary based on a chemistry of the respective layer or a chemistry of the battery cell 120. For example, lithium-ion batteries can include an LFP (lithium iron phosphate) chemistry, an LMFP (lithium manganese iron phosphate) chemistry, an NMC (Nickel Manganese Cobalt) chemistry, an NCA (Nickel Cobalt Aluminum) chemistry, an OLO (Over Lithiated Oxide) chemistry, or an LCO (lithium cobalt oxide) chemistry for a cathode layer (e.g., the cathode layer 255). Lithium-ion batteries can include a graphite chemistry, a silicon-graphite chemistry, or a lithium metal chemistry for the anode layer (e.g., the anode layer 245).

For example, lithium-ion batteries can include an olivine phosphate (LiMPO₄, M=Fe and/or Co and/or Mn and/or Ni)) chemistry, LISICON or NASICON Phosphates (Li₃M₂(PO₄)₃ and LiMPO₄Oₓ, M=Ti, V, Mn, Cr, and Zr), for example lithium iron phosphate (LFP), lithium iron manganese phosphate (LMFP), layered oxides (LiMO₂, M=Ni and/or Co and/or Mn and/or Fe and/or Al and/or Mg) examples, NMC (Nickel Manganese Cobalt) chemistry, an NCA (Nickel Cobalt Aluminum) chemistry, or an LCO (lithium cobalt oxide) chemistry for a cathode layer, lithium rich layer oxides (Li₁₊ₓM₁₋ₓO₂) (Ni, and/or Mn, and/or Co), (OLO or LMR), spinel (LiMn₂O₄) and high voltage spinels (LiMn_{1.5}Ni_{0.5}O₄), disordered rock salt, Fluorophosphates Li₂FePO₄F (M=Fe, Co, Ni) and Fluorosulfates LiMSO₄F (M=Co, Ni, Mn) (e.g., the cathode layer 255). Lithium-ion batteries can include a graphite chemistry, a silicon-graphite chemistry, or a lithium metal chemistry for the anode layer (e.g., the anode layer 245). For example, a cathode layer having an LFP chemistry can have a redox potential of 3.4 V vs. Li/Li⁺, while an anode layer having a graphite chemistry can have a 0.2 V vs. Li/Li⁺ redox potential.

Electrode layers can include anode active material or cathode active material, commonly in addition to a conductive carbon material, a binder, or other additives as a coating on a current collector (metal foil). The chemical composition of the electrode layers can affect the redox potential of the electrode layers. For example, cathode layers (e.g., the cathode layer 255) can include medium to high-nickel content (50 to 80%, or equal to 80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and lithium iron manganese phosphate (“LMFP”). Anode layers (e.g., the anode layer 245) can include conductive carbon materials such as graphite, carbon black, carbon nanotubes, and the like. Anode layers can include Super P carbon black material, Ketjen Black, Acetylene Black, SWCNT, MWCNT, graphite, carbon nanofiber, or graphene, for example.

Electrode layers can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials (e.g., a current collector foil to which an electrode active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

The electrolyte layer 260 can include or be made of a liquid electrolyte material. For example, the electrolyte layer 260 can be or include at least one layer of polymeric material (e.g., polypropylene, polyethylene, or other material) that is wetted (e.g., is saturated with, is soaked with, receives) a liquid electrolyte substance. The liquid electrolyte material can include a lithium salt dissolved in a solvent. The lithium salt for the liquid electrolyte material for the electrolyte layer 260 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. The electrolyte layer 260 can include or be made of a solid electrolyte material, such as a ceramic electrolyte material, polymer electrolyte material, or a glassy electrolyte material, or among others, or any combination thereof.

In some embodiments, the solid electrolyte film can include at least one layer of a solid electrolyte. Solid electrolyte materials of the solid electrolyte layer can include inorganic solid electrolyte materials (e.g., oxides, sulfides, phosphides, ceramics), solid polymer electrolyte materials, hybrid solid-state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂Si₂) and/or sulfide-based lithium argyrodites with formula Li₆PS₅X (X=Cl, Br) like Li₆PS₅Cl). Furthermore, the solid electrolyte layer can include a polymer electrolyte material (e.g., a hybrid or pseudo-solid-state electrolyte), for example, polyacrylonitrile (PAN), polyethylene oxide (PEO), polymethyl-methacrylate (PMMA), and polyvinylidene fluoride (PVDF), among others.

In examples where the electrolyte layer 260 includes a liquid electrolyte material, the electrolyte layer 260 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The electrolyte layer 260 can include at least one additive. The additives can be or include vinylidene carbonate, fluoroethylene carbonate, ethyl propionate, methyl propionate, methyl acetate, ethyl acetate, or a mixture of any two or more thereof. The electrolyte layer 260 can include a lithium salt material. For example, the lithium salt can be lithium perchlorate, lithium hexafluorophosphate, lithium bis(fluorosulfonyl)imide, lithium bis(trifluorosulfonyl)imide, or a mixture of any two or more thereof. The lithium salt may be present in the electrolyte layer 260 from greater than 0 M to about 1.5 M.

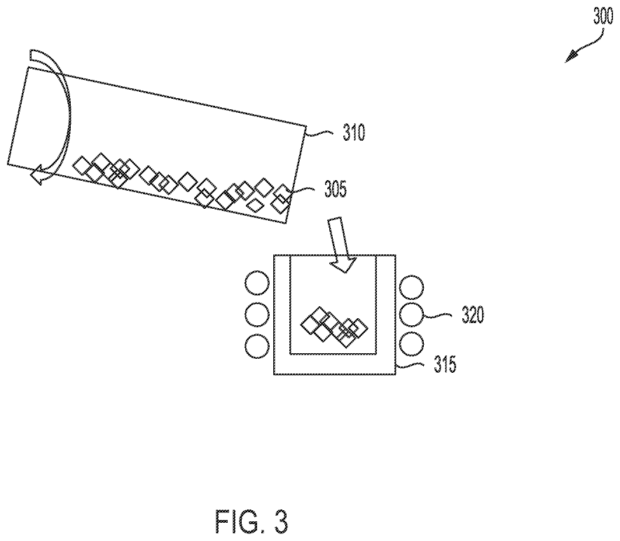

FIG. 3 depicts a perspective view of a system 300 for producing cathode materials. The system 300 can include one or more precursors 305. The precursors 305 can include raw materials. The precursors 305 can include the raw materials that, when melted, can form a lithium metal phosphate, for example lithium iron phosphate or lithium manganese iron phosphate or their derivatives. The lithium metal phosphate can include doped lithium iron phosphates, lithium transition metal phosphates, doped lithium manganese iron phosphates. For example, the precursors 305 can include one or more lithium sources (e.g., LiOH, Li₂CO₃, LiNO₃, Li₃PO₄). The precursors 305 can include one or more iron sources (e.g., Fe₂O₃, Fe₃O₄, Fe powders). The Fe powders can include coarse particles having a size smaller than 1 mm. For example, the course particles can have a diameter or characteristic length of less than 1 mm. The precursors 305 can include one or more phosphate sources (e.g., H₃PO₄, Li₃PO₄, ammonia hydrogen phosphate). The precursors 305 can include a bifunctional precursor such as a metal/dopant and phosphate. The precursors 305 can include a metal phosphate precursor such as MnHPO₄, MnPO₄, FeHPO₄, FePO₄, (Mn₁₋ₓFeₓ)₃(PO₄)₂·xH₂O). In some implementations, a precursor compound can be a precursor for a metal (e.g., transition metal like Fe, Mn), lithium, and/or an anion (e.g., phosphate). The precursors 305 can include graphite (e.g., graphite powder). The precursors 305 can include one or more manganese sources. The precursors 305 can include one or more dopants (e.g., dopant precursors). The dopants can include metal powders, metal oxide powders or any other form of salts containing these metals (e.g., metal carbonate, metal oxalate, or metal nitrate). The dopants can include Al, Ti, Mg, W, V, Co, or any combination thereof. The precursors 305 can include particles having a diameter of less than 1 mm. The precursors 305 can include particles having a diameter of greater than or equal to 1 mm. The precursors 305 can include a powder. The precursors 305 can include LiMn₂O₄, Li₂MnO₃, LiH₂PO₄, or Li₃PO₄.

The system 300 can include one or more first vessels 310. The first vessel 310 can heat the precursors 305 to a first temperature. For example, the first vessel 310 can heat the precursors 305 to the first temperature to form heated precursors. The first temperature can be below a melting point of a solid including a compound formed from the precursors 305. The compound formed from the precursors 305 can include a lithium metal phosphate e.g., LFP and/or LMFP. The melting point of the solid including the compound formed from the precursors 305 can include the melting point of LFP or LMFP. The first vessel 310 can include a rotary kiln. The first vessel 310 can include a device configured to quickly heat the precursors 305. The precursors 305 can be disposed in the first vessel 310 for 1 hour.

The system 300 can include one or more second vessels 315. An example reaction occurring in the second vessel 315 can include 0.7Mn/MnO₂+0.3Fe/Fe₂O₃+H₃PO₄+Li₂CO₃+carbon precursor→LiMn_{0.7}Fe_{0.3}PO₄+flue gas. The second vessel 315 can include a crucible. The second vessel 315 can include a container configured to be subjected to high temperatures. The second vessel 315 can include an agitation mechanism to mix the heated precursors. The heated precursors can be disposed in the second vessel 315 for 30 minutes.

The system 300 can include one or more furnaces 320. The furnace 320 can include one or more heating elements. The furnace 320 can include one or more heating sources. The furnace 320 can include a device configured to produce or output heat. The system 300 can include the battery cell 120. The battery cell 120 can include the solid including the compound formed from the precursors 305. The system 300 can include a cathode including the compound formed from the precursors 305. For example, the cathode can include LFP or LMFP formed from the precursors 305.

The system 300 can include a single vessel in place of the first vessel 310 and the second vessel 315. For example, the first vessel 310 and the second vessel 315 can be combined to form one vessel. The first vessel 310 can be fluidly coupled with the second vessel 315. The single vessel can include a rotary kiln with different temperature zones. The different temperature zones can include a first temperature zone and a second temperature zone. The first temperature zone can reach a temperature below a melting point of the solid including compound formed from the precursors. The second temperature zone can reach a temperature at or above the melting point of the solid including the compound formed from the precursors.

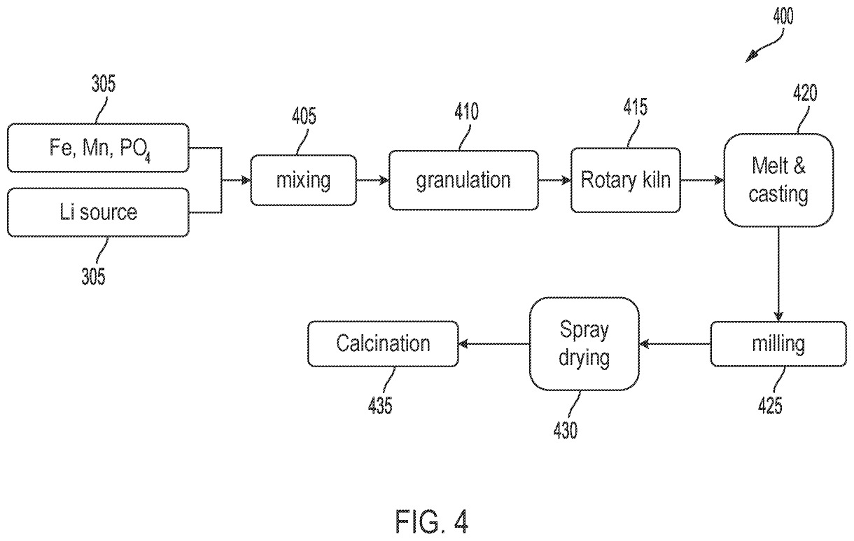

FIG. 4 depicts a perspective view of a method 400 to produce cathode materials. The method 400 can produce cathode materials using a molten process. The method 400 can produce cathode active materials. The cathode active material can include the solid including the compound formed from the precursors 305. The cathode active material can include lithium metal phosphates (e.g., lithium iron phosphate, lithium manganese iron phosphate, lithium transition metal phosphates, and doped derivatives thereof). A battery can include the cathode active material including the solid produced by the method 400. The method 400 can include mixing the precursors 305 (ACT 405). The precursors 305 can include lithium sources, iron sources, phosphate sources, and graphite powders. Lithium sources, iron sources, phosphate sources, and graphite powders can be mixed in a plough mixer. The precursors 305 can be micron-sized. The precursors 305 can include LiMn₂O₄, Li₂MnO₃, LiH₂PO₄, or Li₃PO₄.

The method 400 can include performing a granulation process on the precursors 305 (ACT 410). Granulation can include a process of forming granules from a powder. The raw materials can be granulated by compaction. Granulation can improve the transfer of heat into the precursors 305. The granules can be millimeter-sized.

The method 400 can include heating the precursors 305 in the first vessel 310 (ACT 415). The precursors 305 can be fed into the first vessel 310 as a powder or as granules. For example, the precursors 305 can be fed into the rotary kiln. The precursors 305 can be fed into the first vessel 310 by a screw feeder or any other feeding mechanism for solid feeding. The precursors 305 can be heated in the first vessel 310. The precursors 305 can be heated to a temperature slightly under the melting point. The precursors 305 can have high contact surface and movement in the first vessel 310. The precursors 305 can be partially reacted (e.g., pre-reacted) and sintered in the first vessel 310. The first vessel 310 can be flushed by an inert gas, e.g., Ar, N₂. The precursors 305 in the first vessel 310 can be protected by the flow of an inert gas, e.g., Ar, N₂. The first vessel 310 can be made of stainless steel or graphite. The first vessel 310 can be heated by electric heating. The first vessel 310 can include a discharge port.

The method 400 can include melting the heated precursors in the second vessel 315 (ACT 420). The discharge port of the first vessel 310 can be connected (e.g., fluidly coupled) with a feeding port of the second vessel 315. For example, the discharge port of the rotary kiln can be connected with a top feeding port of the melt furnace. The discharge port of the first vessel 310 can be connected with the feeding port of the second vessel 315 through a line (e.g., pipe). The line can be purged and protected by an inert gas, e.g., N₂. The second vessel 315 can be heated by the furnace 320. The second vessel 315 can be heated by electric resistance heating or induction heating. The second vessel 315 can include a crucible (e.g., melt crucible). The second vessel 315 can be made of ceramics (e.g., ZrO₂, clay, graphite). The precursors 305 can be heated by an electric arc furnace. The heated precursors can be mixed in the second vessel 315. For example, to improve the homogeneity of the reaction, the heated precursors (e.g., molten liquid) can be agitated or stirred using a mechanical impeller driven by a motor. The impeller can stir the molten liquid without forming a dead zone. The melting time in the second vessel 315 can be minimized to suppress side reactions of LFP with the second vessel 315 or reducing agent at the melting temperature. The raw materials or precursors 305 can be fed into the second vessel 315 though a continuous or semi-continuous mechanism. Combing a pre-heating step in a rotary kiln with a melting step in the melt furnace can reduce the time at the melting temperature for the whole batch and increase the throughput in the melt furnace.

The method 400 can include protecting oxidation of the precursors 305. For example, the method 400 can include protecting iron oxidation of the precursors 305 at high temperatures in the solid or liquid state. The precursors 305 can be protected by an inert gas, e.g., N₂ or a reducing environment. The first vessel 310 and the second vessel 315 can be airtight. The first vessel 310 and the second vessel 315 can be fed with N₂ or slightly reducing gas (e.g., N₂/H₂ mixture).

The method 400 can include casting the liquid (e.g., molten liquid) formed by the melted precursors to form a solid. The molten liquid can be discharged from the second vessel 315 by pouring into the molten liquid into a mold. The molten liquid can be discharged from the second vessel 315 by atomization using high pressure an inert gas, e.g., N₂ or argon gas to form powders. The powders can include cathode materials (e.g., LFP, LMFP).

The method 400 can include milling the solid (ACT 425). Milling can include removing material by advancing a cutter into the solid. The method 400 can include spray drying the liquid (ACT 430). Spray drying can include atomization of a solution or slurry. The method 400 can include performing a calcination process on the solid (ACT 435). Calcination can include heating the solid to a high temperature to remove volatile substances.

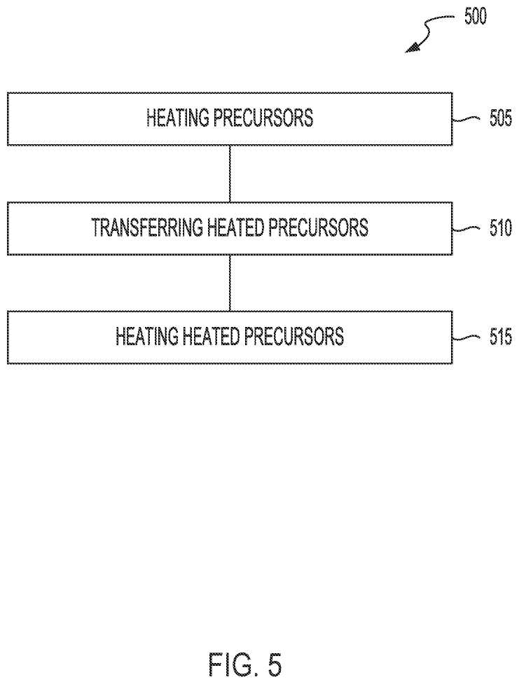

FIG. 5 depicts a perspective view of a method 500 to produce cathode materials. The method 500 can produce cathode materials using a molten process. The method 500 can include heating the precursors 305 (ACT 505). For example, the method 500 can include heating the precursors 305 in the first vessel 310. The method 500 can include heating the precursors 305 in the first vessel 310 to the first temperature to form heated precursors. The first temperature can be below a melting point of the solid including a compound formed from the precursors. For example, the first temperature can be in a range of 900° C. to 950° C. The method 500 can include heating the precursors 305 in the first vessel 310 for 1 hour. The method 500 can produce cathode active materials. The cathode active material can include the solid including the compound formed from the precursors 305. The cathode active material can include lithium metal phosphates (e.g., lithium iron phosphate, lithium manganese iron phosphate, lithium transition metal phosphates, and doped derivatives thereof). A battery can include the cathode active material including the solid produced by the method 500.

The method 500 can include transferring the heated precursors (ACT 510). For example, the method 500 can include transferring the heated precursors from the first vessel 310 to the second vessel 315. The first vessel 310 can include the rotary kiln. The second vessel 315 can include the crucible.

The method 500 can include heating the heated precursors (ACT 515). For example, the method 500 can include heating the heated precursors to the second temperature to form a liquid. The second temperature can be at or above the melting point of the solid including the compound formed from the precursors. The method 500 can include heating, by the furnace 320, the heated precursors to the second temperature to form the liquid. For example, the second temperature can be in in a range of 1000° C. to 1230° C.

The method 500 can include discharging the liquid to form the solid including the compound formed from the precursors 305. For example, the method 500 melt pouring, casting (e.g., casting into an ingot), or atomization. The method 500 can include disposing the solid including the compound formed from the precursors 305 in the battery cell 120 (e.g., battery). The method 500 can include forming a cathode from the solid including the compound formed from the precursors 305.

Compared with a solid-state method of producing cathode materials, the methods 400, 500 can be cheaper because Fe and Fe₂O₃ can be used directly. The methods 400, 500 be free of wastewater management. The methods 400, 500 can be free of a FePO₄ precursor preparation step. The methods 400, 500 can use a smaller plant size than a solid-state method uses. The methods 400, 500 can produce LMFP cathode materials. The methods 400, 500 can use commodity Mn, Fe metal or manganese iron oxide. The methods 400, 500 can use low-cost materials. The methods 400, 500 can form Mn and Fe solid solutions which can enhance LFMP performance. Other methods (e.g., solid-state or sol-gel) may need complicated processes to prepare precursors or complicated reactions to achieve an adequate solid solution of Mn and Fe in LFMP. Mn²⁺ can be more stable, so LFMP can be less prone to oxidation or deterioration than LFP at high temperatures. This can make the melt casting or melt atomization process easier to handle.

The systems and methods described herein can be used for synthesis of phosphate-based cathode materials for lithium-ion batteries. Various polyanionic olivine materials having formula LiMPO₄ (where M=Fe, Mn, Co, Ni, Zn or combinations thereof) with or without cationic substitution of other transition metals in the lattice can be synthesized by the systems and methods described herein. This disclosure describes the synthesis lithium iron phosphate (LFP) and lithium manganese iron phosphate (LMFP) cathode materials for Lithium-ion batteries (LIB s) as non-limiting examples. Other phosphate-based cathode materials (e.g., lithium iron phosphates, lithium manganese phosphates, lithium cobalt phosphates, lithium nickel phosphates, with or without cationic substitution of other transition metals in the lattice) can be similarly synthesized and/or recycled in accordance with the methods described herein.

Compared with the solid-state method of producing cathode materials, the methods 400, 500 can produce cathode materials with a better quality. The higher quality can be due to improved reactions in the molten step with improved crystal structure. Milling (e.g., coarse milling) can be low cost. Compared with the solid-state method of producing cathode materials, it can be easier to make a solid solution of Mn, Fe, Co, Ni or add doping of other elements for the molten processes of methods 400, 500. This can improve the performance of LFMP type of cathode materials. The dopants can include Al, Ti, Mg, W, V, Co, or any combination thereof.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A method, comprising:
heating precursors in a first vessel to a first temperature to form heated precursors, the first temperature below a melting point of a solid comprising a compound formed from the precursors;
transferring the heated precursors from the first vessel to a second vessel; and
heating the heated precursors to a second temperature to form a liquid, the second temperature at or above the melting point of the solid comprising the compound formed from the precursors.

2. The method of claim 1, comprising:
discharging the liquid to form the solid comprising the compound formed from the precursors.

3. The method of claim 1, comprising:
disposing the solid comprising the compound formed from the precursors in a battery.

4. The method of claim 1, comprising:
forming a cathode from the solid comprising the compound formed from the precursors.

5. The method of claim 1, comprising:
the first vessel comprising a rotary kiln.

6. The method of claim 1, comprising:
the second vessel comprising a crucible.

7. The method of claim 1, comprising:
heating, by a furnace, the heated precursors to the second temperature to form the liquid.

8. The method of claim 7, comprising:
the furnace comprising one or more heating elements.

9. The method of claim 1, comprising:
the precursors comprising lithium, iron, phosphate, graphite, manganese, or a combination thereof.

10. The method of claim 1, comprising:
the precursors comprising particles having a diameter of less than 1 mm.

11. The method of claim 1, comprising:
the precursors comprising one or more dopants, the one or more dopants comprising Al, Ti, Mg, W, V, Co, or a combination thereof.

12. The method of claim 1, comprising:
the precursors comprising a powder.

13. The method of claim 1, comprising:
performing a granulation process on the precursors.

14. The method of claim 1, comprising:
the precursors comprising at least one of LiMn₂O₄, Li₂MnO₃, LiH₂PO₄, or Li₃PO₄.

15. A battery comprising:
a cathode active material comprising the solid produced by the method of claim 1.

16. A system, comprising:
a first vessel configured to heat precursors to a first temperature to form heated precursors, the first temperature below a melting point of a solid comprising a compound formed from the precursors;
a second vessel configured to receive the heated precursors; and
a furnace configured to heat the heated precursors to a second temperature to form a liquid, the second temperature at or above the melting point of the solid comprising the compound formed from the precursors.

17. The system of claim 16, comprising:
a battery comprising the solid comprising the compound formed from the precursors.

18. The system of claim 16, comprising:
a cathode comprising the solid comprising the compound formed from the precursors.

19. The system of claim 16, comprising:
the first vessel comprising a rotary kiln; and
the second vessel comprising a crucible.

20. The system of claim 16, comprising:
the precursors comprising at least one of LiMn₂O₄, Li₂MnO₃, LiH₂PO₄, or Li₃PO₄.
